(19) United States
(12) Patent Application Publication
(10) Pub. No.: US 2004/0194713 A1
(43) Pub. Date: Oct. 7, 2004

(54) Bolstered pet bed

(76) Inventors: Nayan Dalal, Woodbridge, NJ (US); Sudarshan Uppuluri, Woodbridge, NJ (US)

Correspondence Address: EZRA SUTTON, PA, PLAZA 9, 900 ROUTE 9, WOODBRIDGE, NJ, 07095, US

(21) Appl. No.: 10/625,577

(22) Filed: Jul. 23, 2003

(30) Foreign Application Priority Data
Jul. 26, 2002 (JP) 2002-218020

(51) Int. Cl. A01K 29/00

(52) U.S. Cl. 119/28.5

(57) ABSTRACT

A bolstered pet bed for the comfort of animal pets. The bolstered pet bed includes an outer covering having first and second interior compartments; and an integrated removable cushion having a bottom cushion and a side cushion integrally connected to each other by a strip of material. The bottom cushion is inserted in the first compartment and the side cushion is inserted in the second compartment. The strip of material extends between and is connected to the bottom cushion and the side cushion; and the strip of material includes a plurality of spaced-apart passageways. The bolstered pet bed further includes a plurality of spaced-apart straps for enclosing the second interior compartment around the side cushion, and which extend through the plurality of spaced-apart passageways. The outer covering includes a zipper member for opening and closing the first interior compartment.

### FIELD OF THE INVENTION

The present invention relates to a bolstered pet bed for the comfort of animal pets. More particularly, to a bolstered pet bed having a removable and integrated cushion consisting of a bottom cushion attached to a side cushion.

### BACKGROUND OF THE INVENTION

Pet beds were originally devised for both the comfort of pets (i.e., dogs, cats, etc.) and to keep the pets from sitting, sleeping, laying on household and bedroom furniture, such as sofas, living room chairs, couches and beds. Although simple throw cushions are often used as a pet bed, many pets would prefer a favorite household couch or owner's bed rather than sleep or lay on a mere cushion, as the pet needs to feel secure and is reluctant to leave the owner's sofa, chair or bed.

Most pet beds are used on a floor area in a predetermined location within the owner's home or dwelling, such that the pet is expected to make this location and its pet bed the resting and sleeping place for his or her territorial area in order to feel secure for that location.

Typically, these prior art pet beds include a horizontal bed surface made of a soft, flexible material which is partially surrounded or fully surrounded by a vertical annular wall attached to the horizontal bed surface. The vertical annular wall portion extends upwardly from the perimeter of the horizontal bed surface of the pet bed, leaving an opening through which the pet can enter or leave, and also allowing the pet to see out even while in a supine and lying position. The vertical wall portion is also used as a headrest by the pet who feels safer and has a better view of the surroundings.

There remains a need for a bolstered pet bed having a one piece removable and integrated cushion with a bottom cushion fixedly attached to a side cushion and being received within a single outer covering. Additionally, the outer covering would include a plurality of strap members for enclosing the side cushion interior compartment around the side cushion.

### DESCRIPTION OF THE PRIOR ART

Pet beds, pet pillows, pet rolls, pet cushions, pet lounges and the like having various designs, structures, configurations and materials of construction have been disclosed in the prior art. For example, U.S. Pat. No. 4,860,689 to STEWART discloses a pet lounge having a base member, a body support platform for resting on the base member and for providing a body support for the pet, and a bolster for surrounding at least a portion of the body support platform and for providing a headrest for the pet; the body support platform being vertically adjustable relative to the bolster. This prior art patent does not disclose the design, structure and configuration of the present invention.

U.S. Pat. No. 5,010,843 to HENRY discloses a pet bed including a pair of semi-circular cushions connected along their circumferential perimeters to a circular cushion having substantially the same radius as the semi-circular cushions. The opposed diametral edges of the semi-circular cushions are unattached leaving a trough between them. A pocket is formed between the adjacent surfaces of the semi-circular and circular cushions whereby a pet may crawl into the pocket for resting and sleeping or may lie in the trough surrounded on two sides by the diametral edges of the semi-circular cushions. This prior art patent does not disclose the design, structure and configuration of the present invention.

U.S. Pat. No. 5,197,411 to SCHWARZENBART discloses a pet bed which is flexible and compliant to any surface of furniture or flooring and protects the same from damage by the pet. The pet bed includes a bed body which has a continuous edge, and a roll with a relatively uniform cross section, which extends around a major portion of the edge to enclose a major portion of the bed body. Both the bed body and roll include a padding material which has a drape similar to that of a sleeping bag or bed comforter This prior art patent does not disclose the design, structure and configuration of the present invention.

U.S. Pat. No. 5,765,502 to HAUGHN discloses a pet bed including an outer covering, a removable cushion disposed within the outer covering to form a cushioned bottom potion, and a bolster removably affixed to the interior of the outer covering and disposed about at least a portion of the perimeter of the bottom portion. The outer covering further includes a reclosable access opening permitting both the bottom cushion and bolster to be removed as needed. The prior art patent does not disclose the design, structure and configuration of the present invention.

None of these prior art patents teach or disclose the structure of a bolstered pet bed having a removable and integrated cushion consisting of a bottom cushion fixedly attached to a side cushion as shown in the present invention.

Accordingly, it is an object of the present invention to provide a bolstered pet bed having a bottom cushion connected to a side cushion by a strip member which forms a removable and integrated cushion that is received within first and second interior compartments of an outer covering.

Another object of the present invention is to provide a bolstered pet bed that has the bottom cushion being received within the first interior compartment and the side cushion being received within the second interior compartment of the outer covering for providing a bed surface to the pet, as well as a headrest surface for the pet.

Another object of the present invention is to provide a bolstered pet bed that has a plurality of strap members for enclosing the second interior compartment around the side cushion in order to raise the side cushion relative to the bottom cushion in order to afford a raised headrest surface for the pet.

Another object of the present invention is to provide abolstered pet bed that is easily maintained, easy to clean, and promotes good pet hygiene.

Another object of the present invention is to provide a bolstered pet bed that uses a single outer covering which is readily washable.

A further object of the present invention is to provide a bolstered pet bed that can be mass produced in an automated and economical manner and is readily affordable by the pet owner.

### SUMMARY OF THE INVENTION

In accordance with the present invention, there is provided a bolstered pet bed for the comfort of animal pets. The bolstered pet bed includes an outer covering having first and second interior compartments; and an integrated removable cushion having a bottom cushion and a side cushion integrally connected to each other by a strip of material. The bottom cushion is inserted in the first compartment and the side cushion is inserted in the second compartment. The strip of material extends between and is connected to the bottom cushion and the side cushion; and the strip of material includes a plurality of spaced-apart passageways. The bolstered pet bed further includes a plurality of spaced-apart straps for enclosing the second interior compartment around the side cushion, and which extend through the plurality of spaced-apart passageways. The outer covering includes a zipper member for opening and closing the first interior compartment.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a front perspective view of the bolstered pet bed of the preferred embodiment of the present invention showing the bolstered pet bed in its assembled configuration;

FIG. 2 is a bottom perspective view of the bolstered pet bed of the present invention showing a zipper member in a closed position on an outer covering;

FIG. 3 is an exploded perspective view of the bolstered pet bed of the present invention showing an integrated removable cushion being inserted within first and second interior compartments of the outer covering;

FIG. 4 is a partial bottom perspective view of the bolstered pet bed of the present invention showing a plurality of spaced-apart straps for enclosing the second interior compartment around a side cushion;

FIG. 4A is an enlarged top plan view of the bolstered pet bed of the present invention showing first and second strap elements of the strap member in an opened configuration prior to enclosing of the second interior compartment around the side cushion;

FIG. 4B is enlarged top plan view of the bolstered pet bed of the present invention showing the strap member in a closed configuration after the enclosing of the second interior compartment around the side cushion;

FIG. 5 is a top plan view of the bolstered pet bed of the present invention showing a top surface area of the outer covering;

FIG. 6 is a top plan view of the bolstered pet bed of the present invention showing a bottom cushion and a side cushion integrally connected to each other by multiple spaced-apart strip sections;

FIG. 7 is a cross-section view of the bolstered pet bed of the present invention taken along lines 7-7 of FIG. 1 in the direction of the arrows showing a filling material within each of the bottom and side cushions.

### DETAILED DESCRIPTION OF THE PREFERRED EMBODIMENT

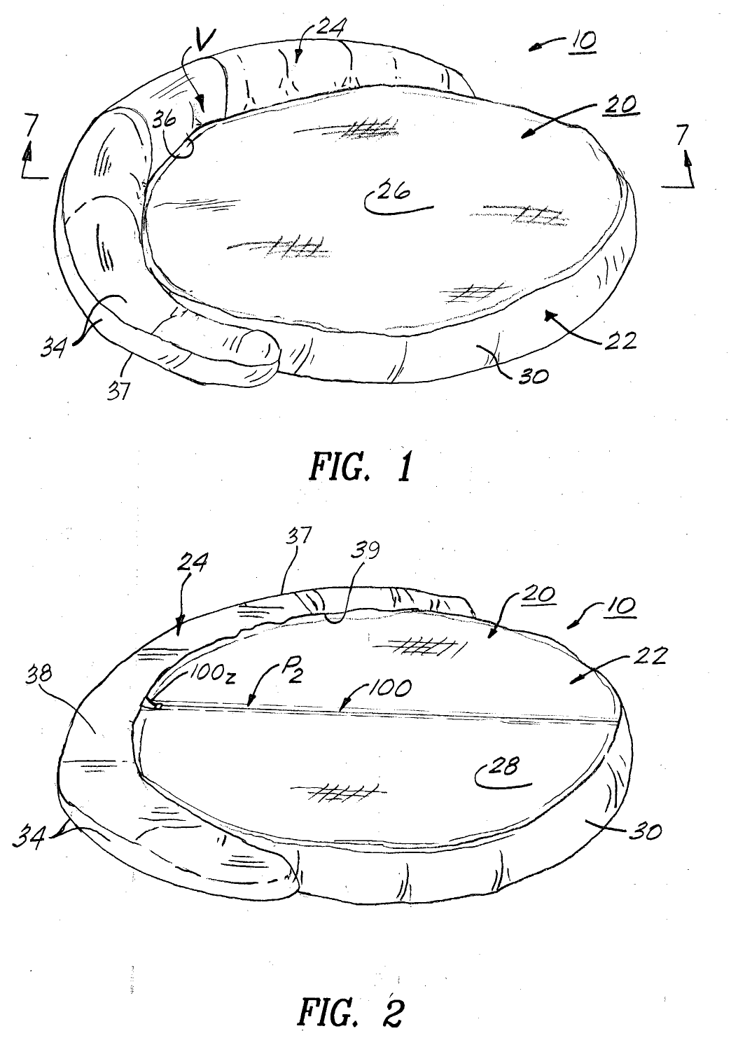

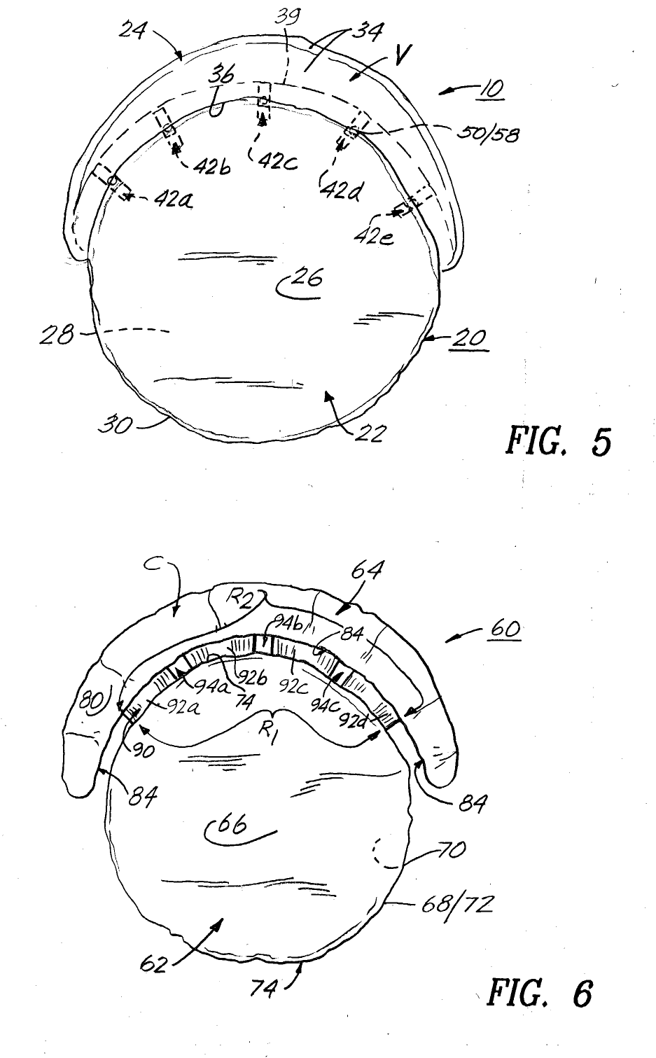

The bolstered pet bed 10 and its component parts of the preferred embodiment of the present invention is represented in detail by FIGS. 1 through 8 of the patent drawings. The bolstered pet bed 10 is used for the comfort of animal pets.

As shown in FIGS. 1 to 5, the bolstered pet bed 10 includes an outer covering 20 having a bottom cushion section 22 integrally connected to a side cushion section 24. The bottom cushion section 22 includes a top wall 26, a bottom wall 28 and a circumferential perimeter (side) wall 30 for forming a first interior compartment 32. The side cushion section 24 includes a U-shaped top wall 34 having a front perimeter edging 36 and a rear perimeter edging 37 and a bottom wall 38 having an inner perimeter edging 39. The front and rear perimeter edging 36 and 37 of the U-shaped top wall 34 is fixedly attached to a portion of the top wall 26 of bottom cushion section 22 and to the bottom wall 38 of the side cushion section 24, respectively, and the inner perimeter edging 39 of the bottom wall 38 of the side cushion section 24 is also fixedly attached to the bottom wall 28 of the bottom cushion section 22, for forming a second interior compartment 40, as depicted in FIGS. 1 to 3 of the drawings.

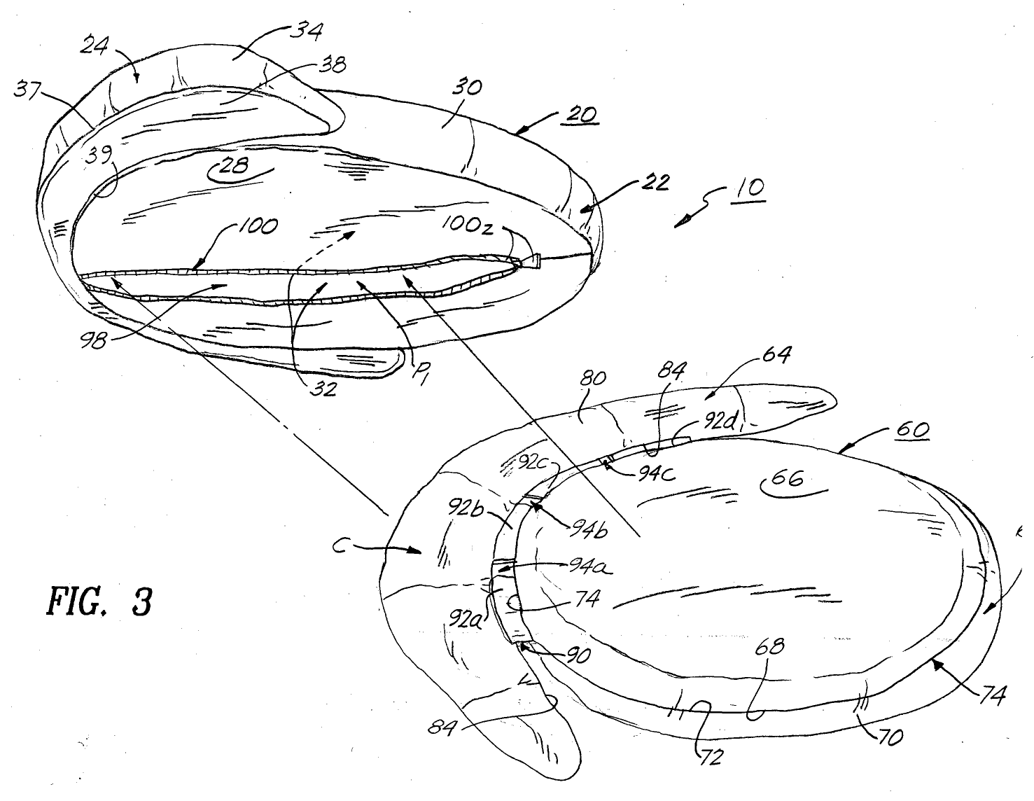

The bolstered pet bed 10, as shown in FIGS. 3, 6 and 7, includes an integrated removable cushion 60 having a bottom cushion 62 and a side cushion 64. The bottom cushion 62 includes a top cushion wall 66 having a circumferential perimeter edging 68 and a bottom cushion wall 70 having a circumferential perimeter edging 72. Each of the circumferential perimeter edges 68 and 72 of the top and bottom cushion walls 66 and 70, respectively, are sewn together at a seam line 74 to form an interior bottom cushion compartment 76 for receiving a polyester fiber fill 78 therein. The side cushion 64 includes an outer wall 80 formed in a substantially crescent-shape C having an interior side cushion compartment 82 for receiving the polyester fiber fill 76 therein. The outer wall 80 of side cushion 64 also includes a seam line 84.

The bottom cushion 62 and the side cushion 64 are integrally connected to each other by a strip member 90 made of canvas material. The strip member 90 is connected by sewing to each of the seam lines 74 and 84 of the bottom and side cushions 62 and 64, respectively, as shown in FIGS. 3 and 6 of the drawings. The strip member 90 extends along a perimeter section R₁ of the bottom cushion 62 and extends along a perimeter section R₂ of the side cushion 64, as depicted in FIG. 6. The strip member 90 includes at least four (4) spaced-apart strip sections 92a, 92b, 92c and 92d that form at least three (3) spaced-apart passageways 94a, 94b and 94c. The three (3) spaced-apart passageways 94a, 94b, and 94c are positioned between each of the four (4) spaced-apart strip sections 92a, 92b, 92c and 92d, accordingly, as shown in FIGS. 3 and 6 of the drawings.

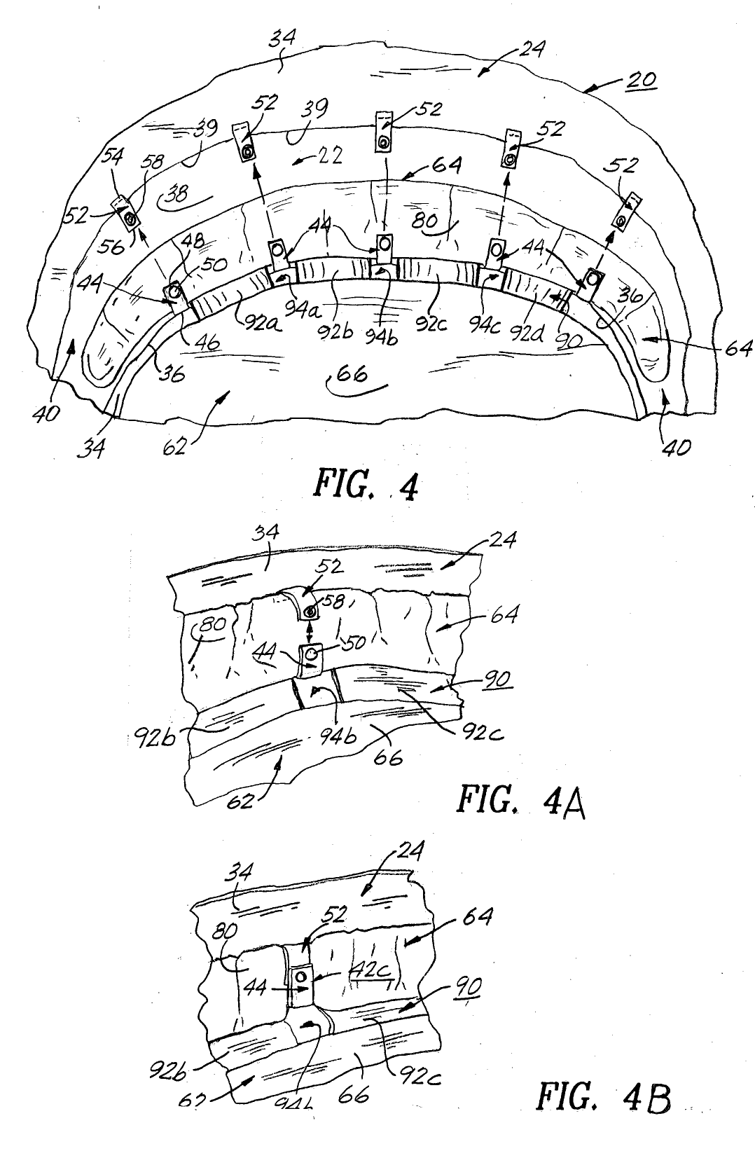

Additionally, as shown in FIGS. 4,4A and 4B, the second interior compartment 40 includes a plurality of spaced-apart strap members 42a, 42b, 42c, 42d and 42e therein. Each strap member 42a to 42e includes a first strap element 44 and a second strap element 52. The first strap element 44 includes a proximal end 46 sewn to the front perimeter edging 36 of top wall 34 of the bottom cushion section 22 and a distal end 48 having a male snap element 50 attached thereto. The second strap element 52 includes a proximal end 54 sewn to the rear perimeter edging 39 of bottom wall 38 of the side cushion section 24 and a distal end 56 having a female snap element 58 attached thereto. Each of the five (5) spaced-apart strap members 42a to 42e are used for enclosing the second interior compartment 40 around the side cushion 64 in order to hold the side cushion 64 in place relative to the adjacent and attached bottom cushion 62. Further, the middle three (3) spaced-apart strap members 42b, 42c and 42d (with their corresponding strap elements 44 and 52 being fastened by their respective male and female snap elements 50 and 58 together accordingly) extend through the three (3) spaced-apart passageways 94a, 94b and 94c, respectively, as depicted in FIG. 4 of the drawings.

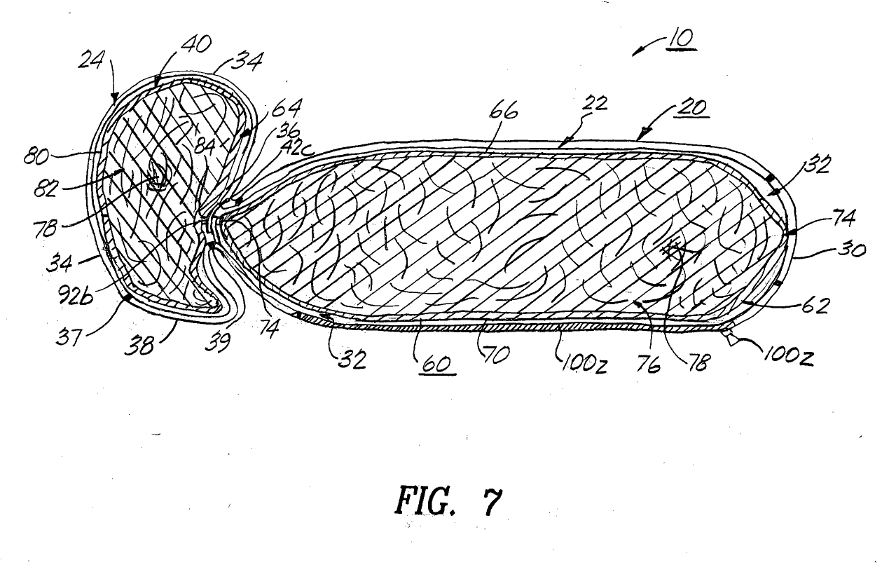

Also, the bottom wall 28 of the bottom cushion section 22 includes an access opening 98 for inserting the removable and integrated cushion 60 within each of the first and second interior compartments 32 and 40, accordingly. The access opening 98 includes closure means 100 for opening and closing the first interior compartment 32 of outer covering 20, as shown in FIGS. 2 and 7 of the drawings. Closure means 100 can be selected from the group consisting of a zipper member 100z, male and female snaps, string ties, button element, hook and loop fasteners, male and female metal fasteners and the like.

The physical dimensions of the bolstered pet bed 10 is as follows: The bottom cushion 62 being circularly-shaped has a diameter of 32 inches and a depth of 10 inches at the center of the bottom cushion 62. The side cushion 64 being crescent-shaped has a length of 66 inches and a maximum width of 10½ inches. Each of the spaced-apart strip section 92a and 92d has a length of 9 inches and a width of 1½ inches. Each of the spaced-apart passageways 94a to 94c has a length of 2 inches and a width of 1½ inches. The bolstered pet bed 10 in the assembled state has a maximum width of 35 inches with the side cushion 64 having a height of 8 inches and a width of 2½ inches. The distance between each of the spaced-apart strap members 42a to 42e is 11 inches. Each of the strap members 42a to 42c has a length of 2 inches and a width of ½ inch.

### OPERATION OF THE PRESENT INVENTION

In assembling of the bolstered pet bed 10, as shown in FIG. 3, the manufacturer or user inserts the bolstered cushion 60 through the access opening 98 by opening the zipper member 100z on the bottom wall 28 of the outer covering 20 to an opened configuration P₁. The bolstered cushion 60 is then positioned within each of the first and second interior compartments 32 and 40, such that the bottom cushion 62 is placed and positioned within the first interior compartment 32 and the side cushion 64 is placed and positioned within the second interior compartment 40 of the outer covering 20. The manufacturer or user now places and positions each of the corresponding first and second strap elements 44 and 52 for the middle strap members 42b, 42c and 42d through the three (3) spaced-apart passageways 94a, 94b and 94c, respectively, where then each of the corresponding male and female snap elements 50 and 58 are fastened together. Next, each of the five (5) spaced-apart strap members 42a to 42e enclose the second interior compartment 40 around the side cushion 64 in order to hold the side cushion 64 in a vertical position V relative to the adjacent and horizontally positioned bottom cushion 62, as shown in FIGS. 1 and 4 of the drawings. The user/manufacturer now closes the access opening 98 by closing the zipper member 100z on the bottom wall 28 of the outer covering 20 to a closed configuration P₂, as depicted in FIG. 2. The bolstered pet bed 10 is now in condition f or use by the pet animal.

### ADVANTAGES OF THE PRESENT INVENTION

Accordingly, an advantage of the present invention is that is provides for a bolstered pet bed having a bottom cushion connected to a side cushion by a strip member which forms a removable and integrated cushion that is received within first and second interior compartments of an outer covering.

Another advantage of the present invention is that it provides for a bolstered pet bed that has the bottom cushion being received within the first interior compartment and the side cushion being received within the second interior compartment of the outer covering for providing a bed surface to the pet, as well as a headrest surface for the pet.

Another advantage of the present invention is that it provides for a bolstered pet bed that has a plurality of strap members for enclosing the second interior compartment around the side cushion in order to raise the side cushion relative to the bottom cushion in order to afford a raised headrest surface for the pet.

Another advantage of the present invention is that it provides for a bolstered pet bed that is easily maintained, easy to clean, and promotes good pet hygiene.

Another advantage of the present invention is that it provides for a bolstered pet bed that uses a single outer covering which is readily washable.

A further advantage of the present invention is that it provides for a bolstered pet bed that can be mass produced in an automated and economical manner and is readily affordable the pet owner.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A bolstered pet bed, comprising:
a) an outer covering having first and second interior compartments;
b) an integrated removable cushion having a bottom cushion and a side cushion integrally connected to each other by a strip of material;
c) said bottom cushion being in said first compartment and said side cushion being in said second compartment;
d) said strip of material extending between and connected to said bottom cushion and said side cushion; and said strip of material having a plurality of spaced-apart passageways;
e) strap means for enclosing said second interior compartment around said side cushion; said strap means including a plurality of spaced-apart straps extending through said plurality of spaced-apart passageways; and
f) closure means for opening and closing said first interior compartment.

2. A bolstered pet bed in accordance with claim 1, wherein said strip of material is made of canvas tape and has at least four (4) spaced-apart strip sections.

3. A bolstered pet bed in accordance with claim 2, wherein each of said strip sections has a length of 9 inches and a width of 1.5 inches.

4. A bolstered pet bed in accordance with claim 2, wherein said plurality of passageways includes at least three (3) spaced-apart passageways between said four (4) strip sections, each of said spaced-apart passageways has a length of 2 inches and a width of 1.5 inches.

5. A bolstered pet bed in accordance with claim 1, wherein said side cushion is semi-circular in shape and has a length of 66 inches and a maximum width of 10.5 inches.

6. A bolstered pet bed in accordance with claim 1, wherein said bottom cushion has a diameter of 32 inches and a depth of 10 inches at the center of said bottom cushion.

7. A bolstered pet bed in accordance with claim 4, wherein said plurality of straps include at least five (5) straps; wherein three (3) of said straps extend through three (3) of said spaced-apart passageways.

8. A bolstered pet bed in accordance with claim 7, wherein the length of each of said straps is 2 inches and includes snap fastening means for fastening each strap around said side cushion.

9. A bolstered pet bed in accordance with claim 8, wherein said snap fastening means include a male snap and a female snap.

10. A bolstered pet bed in accordance with claim 1, wherein said closure means for opening and closing said first interior compartment are selected from the group consisting of a zipper, male and female snaps, string ties, button elements, hook and loop fasteners, and male and female metal fasteners.

11. A bolstered pet bed in accordance with claim 1, wherein said bottom cushion and said side cushion each have a filling of polyester fiber.
